(19) United States
(12) Patent Application Publication
(10) Pub. No.: US 2017/0080307 A1
(43) Pub. Date: Mar. 23, 2017

(54) BALL BAT BODY

(71) Applicant: Jung-Shih CHANG, TAICHUNG CITY (TW)

(72) Inventor: Jung-Shih CHANG, TAICHUNG CITY (TW)

(21) Appl. No.: 14/882,752

(22) Filed: Oct. 14, 2015

(30) Foreign Application Priority Data
Sep. 17, 2015 (CN) 201510591905.5

(51) Int. Cl. A63B 59/54; B29C 70/34; B29C 33/46; B29C 70/22

(52) U.S. Cl. CPC A63B 59/54; B29C 70/22; B29C 70/345; B29C 33/46; B29L 2031/52

(57) ABSTRACT

A ball bat body extends along a longitudinal axis and comprises a front section and a rear section. The front section includes a first tubular member and the rear section includes a second tubular member. The first tubular member is formed by a first fiber-reinforced resin sheet with a first connecting portion. The second tubular member is formed by a second fiber-reinforced resin sheet with a second connecting portion. The fibers of the first fiber-reinforced resin sheet extend in a first angle relative to the longitudinal axis of the bat body. The fibers of the second fiber-reinforced resin sheet extend in a second angle relative to the longitudinal axis of the bat body. The first connecting portion of the first fiber reinforced resin sheet and the second connecting portion of the second fiber reinforced resin sheet are linked up in an un-overlapping or overlapping way.

### BACKGROUND OF THE INVENTION

1. Field of the Invention

The present invention relates to ball bats and more particularly to a ball bat body made of fiber-reinforced resin materials and a method to produce it.

2. Description of the Related Art

It was known that the conventional ball bats are generally made of wood, metal, fiber-reinforced resin material or a combination of them. Yet for having good performance and durability, the bat constructed entirely with fiber-reinforced resin materials predominated over the other conventional ball bats. The traditional fiber-reinforced resin ball bats, as disclosed in U.S. Pat. No. 4,848,745 and U.S. Pat. No. 5,395,108, normally included multiple sleeves and each of sleeves is formed by a single sheet of fiber-reinforced resin materials through the roll wrapping process.

As is known, a typical ball bat usually includes a hitting section, a tapered section and a handle section. Based on prior experience, for having a preferred performance, each of sections must have its own property for serving different function. For example, the hitting section should be more stiff than the other sections and the tapered section should be more flexible than the hitting section. However, for each of sleeves of the prior art ball bat body is formed by a single sheet of fiber-reinforced resin materials so that all of sections of the prior art ball body have a uniform property. In other words, the prior art fiber-reinforced resin ball bat body can not reflect such demand perfectly.

Thus, it is an object of the present invention to provide a ball bat body of fiber-reinforced resin materials wherein each section thereof has its specific property.

It is yet another object of this invention is to provide a method for producing a ball bat body of fiber-reinforced resin materials wherein each section thereof has its specific property.

### SUMMARY OF THE INVENTION

Accordingly, a ball bat body provided by one aspect of the present invention extends along a longitudinal axis and comprises a front section and a rear section coupled with the front section. The front section includes at least a first tubular member and the rear section includes at least a second tubular member. The first tubular member is formed by a first fiber-reinforced resin sheet having a first set of left-extended fibers and a first set of right-extended fibers. The first set of left-extended fibers extends at a plus first angle relative to the longitudinal axis of the bat body. The first set of right-extended fibers extends at a minus first angle relative to the longitudinal axis of the bat body. The first fiber-reinforced resin sheet further has a first connecting portion disposed on one end thereof. The second tubular member is formed by a second fiber-reinforced resin sheet having a second set of left-extended fibers and a second set of right-extended fibers. The second set of left-extended fibers extends at a plus second angle relative to the longitudinal axis of the bat body. The second set of right-extended fibers extends at a minus second angle relative to the longitudinal axis of the bat body. The second sheet further has a second connecting portion disposed on one end thereof. The first connecting portion of the first fiber reinforced resin sheet and the second connecting portion of the second fiber reinforced resin sheet are linked up in an un-overlapping or overlapping way such that the first tubular member and the second tubular member are coupled with each other.

A ball bat body provided by another aspect of the present invention further comprises a middle section located between the front and rear sections. The middle section includes at least a third tubular member comprising a third fiber-reinforced resin sheet having a third set of left-extended fibers and a third set of right-extended fibers. The third set of left-extended fibers extends at a plus third angle relative to the longitudinal axis of the bat body. The third set of right-extended fibers extends at a minus third angle relative to the longitudinal axis of the bat body. The third fiber-reinforced resin sheet further has a third connecting portion disposed on one end thereof and a fourth connecting portion disposed on the other end thereof. The third connecting portion of the third fiber reinforced resin material sheet and the first connecting portion of the first fiber reinforced resin material sheet are linked up in an un-overlapping or overlapping way such that the third tubular member and the first tubular member are coupled with each other. The fourth connecting portion of the third fiber reinforced plastic sheet and the second connecting portion of the second fiber reinforced plastic sheet are linked up in an un-overlapping or overlapping way such that third tubular member and the second tubular member are coupled with each other.

Furthermore, the present invention further provides a method for producing the bat body mentioned above. The method comprises the steps of:

preparing a mandrel with an air bladder and a longitudinal axis;

preparing a first fiber-reinforced resin sheet having a first set of left-extended fibers and a first set of right-extended fibers, the first set of left-extended fibers extending at a plus first angle relative to the longitudinal axis of the mandrel, the first set of right-extended fibers extending at a minus first angle relative to the longitudinal axis of the mandrel;

disposing a first connecting portion on one end of the first fiber-reinforced resin sheet;

wrapping the first fiber-reinforced resin sheet about a first part of the mandrel to form a first tubular member;

preparing a second fiber-reinforced resin sheet having a second set of left-extended fibers and a second set of right-extended fibers, the second set of left-extended fibers extending at a plus second angle relative to the longitudinal axis of the mandrel, the second set of right-extended fibers extending at a minus second angle relative to the longitudinal axis of the mandrel;

disposing a second connecting portion on one end of the second fiber-reinforced resin material sheet;

wrapping said second fiber-reinforced resin sheet about a second part of the mandrel in such a way that the first connecting portion of said first fiber reinforced resin material sheet is linked up un-overlappingly or overlappingly with the second connecting portion of the second fiber-reinforced resin sheet to form a second tubular member;

placing the first and second tubular members into a mold; and

compacting and simultaneously heat curing the first and second tubular members in a period of time for hardening the first and second tubular members to form the ball bat body.

### BRIEF DESCRIPTION OF THE DRAWINGS

The present invention will become more fully understood from the following detailed description with reference to the accompanying drawings, in which:

FIG. 1 is a side view of a ball bat divided into two sections.

FIG. 2 is a side view of a bat body in accordance with a first preferred embodiment of the present invention.

FIG. 3 is a side view of a first fiber-reinforced resin sheet being used to form a first tubular member of the bat body of FIG. 2.

FIG. 4 is a side view of a second fiber-reinforced resin sheet being used to form a second tubular member of the bat body of FIG. 2.

FIG. 5 illustrates the first fiber-reinforced resin sheet being wrapped about a first part of a mandrel to form the first tubular member.

FIG. 6 illustrates a preferred way to form a section of a bat body laminated by multiple tubular members.

FIG. 7 is a side view of a bat body in accordance with a second preferred embodiment of the present invention.

FIG. 8 is a side view of a ball bat divided into three sections.

FIG. 9 is a side view of a bat body in accordance with a third preferred embodiment of the present invention.

FIG. 10 is a side view of a third fiber-reinforced resin sheet being used to form a third tubular member of the bat body of FIG. 9.

FIG. 11 illustrates a method for producing the bat body of FIG. 9 wherein a first and third fiber-reinforced resin sheets are wrapped about a mandrel orderly to form a first and third tubular members.

### DETAILED DESCRIPTION OF THE INVENTION

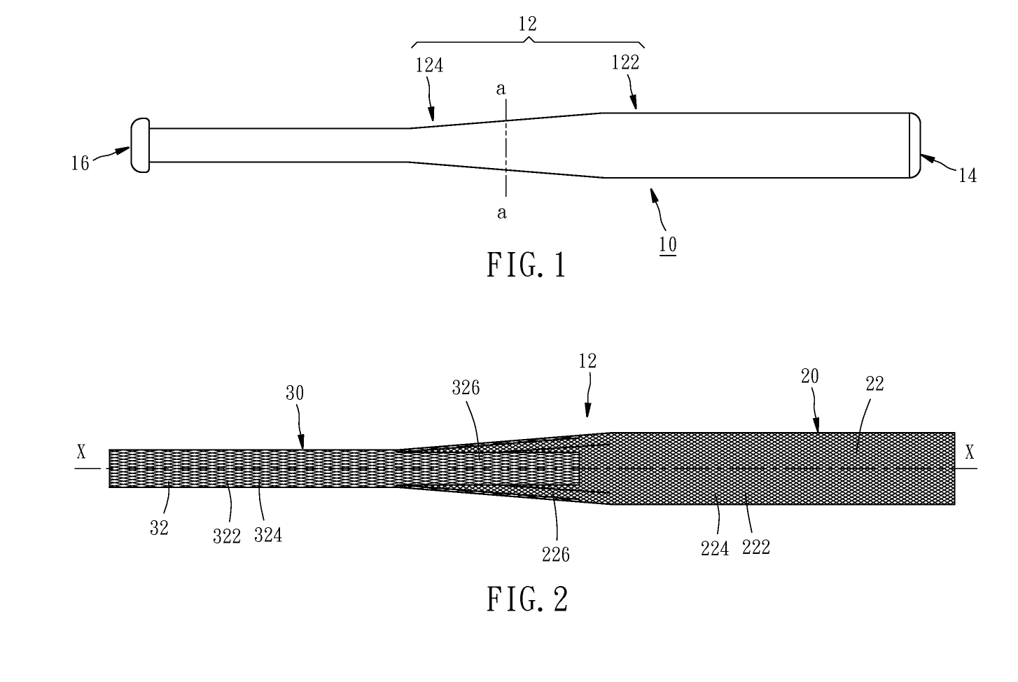

Referring firstly to FIGS. 1 and 2, a baseball bat is generally indicated at 10. However, the present invention can also be a softball bat or other form of ball bat. The ball bat 10 includes a bat body 12 extending along a longitudinal axis X-X′, a top cap 14 and a butt 16. The bat body 12 includes a front section 122 and a rear section 124, which are separated by a dotted line a-a′ as shown in FIG. 1. Normally, the front section 122 corresponds to the hitting portion of the ball bat 10. The rear section 124 corresponds to the handle portion of the ball bat 10.

The front section 122 comprises at least a first tubular member 20. The rear section 124 comprises at least a second tubular member 30. The first and second tubular members 20, 30 are both made of fiber-reinforced resin materials. Here, the fiber-reinforced resin material means a material of fiber reinforcement impregnated in a resin matrix. The resin matrix can be a thermoplastic resin or a thermosetting resin. Generally, the fibers of the fiber reinforcement are long fibers selected from the group consisting of glass fiber, boron fiber, carbon fiber and aramid fiber.

In this embodiment, the first tubular member 20 is made from a first carbon fiber-reinforced epoxy sheet 22 having a first set of left-extended fibers 222 and a first set of right-extended fibers 224. The first set of left-extended fibers 222 extends at +30 degrees (the plus first angle) relative to the longitudinal axis X-X′ of the bat body 12. The first set of right-extended fibers 224 extends at −30 degrees (the minus first angle) relative to the longitudinal axis X-X′ of the bat body 12. The first carbon fiber-reinforced epoxy sheet 22 has a first connecting portion 226 disposed on one end thereof.

The second tubular member 30 is made from a second carbon fiber-reinforced epoxy sheet 32 having a second set of left-extended fibers 322 and a second set of right-extended fibers 324. The second set of left-extended fibers 322 extends at +10 degrees (the plus second angle)relative to the longitudinal axis X-X′ of the bat body 12. The second set of right-extended fibers 324 extends at −10 degrees (the minus second angle) relative to the longitudinal axis X-X′ of the bat body 12. The second carbon fiber-reinforced epoxy sheet 32 has a second connecting portion 326 disposed on one end thereof. The second connecting portion 326 and the first connecting portion 226 of the first fiber reinforced resin material sheet 22 are linked up in an un-overlapping or overlapping way. Here, as shown in FIG. 2, they are linked up overlappingly.

In this embodiment, because the degrees of the first angle are greater than that of the second angle, when the bat body hits the ball, the first tubular member 20 not only can bear more twisting force than the second tubular member 30 but is more flexible than the second tubular member 30.

Furthermore, in an alternative preferred embodiment, each of the front and rear sections 122, 124 may be laminated by multiple tubular members. Since the front section 122 corresponds to the hitting portion of the ball bat 10, the number of the first tubular members 20 would be greater than that of the second tubular member 30. For example, the front section 122 has sixteen first tubular members 20 and the rear section 124 just has ten second tubular member 30. And the result is that the front section 122 is more stiff than the rear section 124.

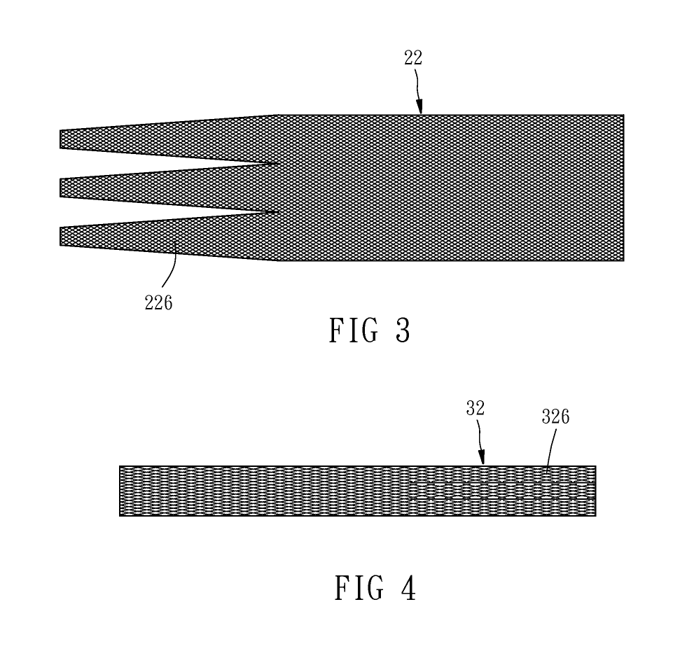

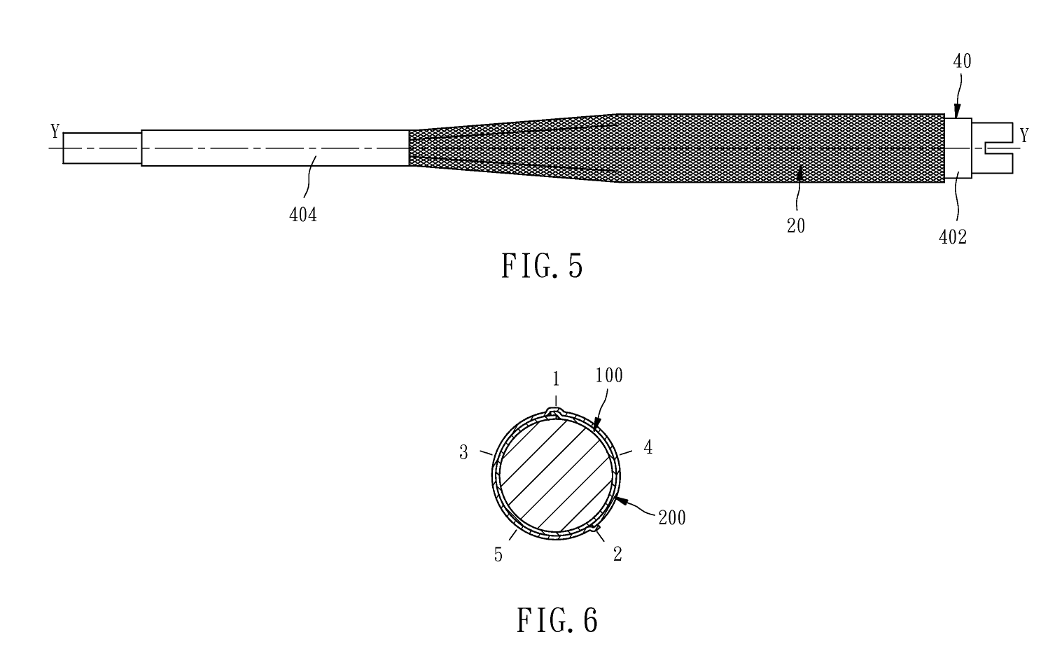

Referring secondly to FIGS. 3 to 6, the method for producing the bat body 12 comprises the steps of:

preparing a mandrel 40 with an air bladder and extending along a longitudinal axis Y-Y′ (The air bladder is not shown in the drawings for being a well-known prior art);

preparing a first carbon fiber-reinforced epoxy sheet 22 having a first set of left-extended fibers 222 and a first set of right-extended fibers 224, the first set of left-extended fibers extending at +30 degrees relative to the longitudinal axis Y-Y′ of the mandrel 40, the first set of right-extended fibers 224 extending at −30 degrees relative to the longitudinal axis Y-Y′ of the mandrel 40;

disposing a first saw-toothed connecting portion 226 on one end of the first carbon fiber-reinforced epoxy sheet 22, as shown in FIG. 3;

wrapping the first carbon fiber-reinforced epoxy sheet 22 about a first part 402 of the mandrel 40 to form a first tubular member 20;

preparing a second carbon fiber-reinforced epoxy sheet 32 having a second set of left-extended fibers 322 and a second set of right-extended fibers 324, the second set of left-extended fibers extending at +10 degrees relative to the longitudinal axis Y-Y′ of the mandrel 40, said second set of right-extended fibers 324 extending at −10 degrees relative to the longitudinal axis Y-Y′ of the mandrel 40;

slicing one end of the second carbon fiber-reinforced epoxy sheet 32 into a plurality of strips to form a second connecting portion 326, as shown in FIG. 4;

wrapping the second carbon fiber-reinforced epoxy sheet 32 about a second part 404 of the mandrel 40 in such a way that the second connecting portion 326 of the second carbon fiber-reinforced epoxy sheet 32 is linked up overlappingly with the first connecting portion 226 of the first carbon fiber-reinforced epoxy sheet 22 to form a second tubular member 30 coupled with the first tubular member 20;

placing the first and second tubular members 20,30 into a mold; and

compacting the first and second tubular members 20,30 with 11 KG/CM2 by the air bladder and simultaneously heat curing the first and second tubular members 20,30 at 132˜138° C. in a period of time for hardening them to form the bat body 12.

Moreover, when the front and rear sections are laminated by multiple tubular members, one aspect of the method provided by the present invention is to prepare a plurality of the fiber-reinforced resin sheets and wrap each of the sheets orderly about a mandrel at a different starting point so that each section would have a uniform wall thickness. For example, if one section of the bat body is laminated by five tubular members, as shown in FIG. 6, there has five starting points marked as 1 to 5 in a sectional view of the mandrel. The first sheet 100 is wrapped about the mandrel initially from the starting point “1”. The second sheet 200 is wrapped about the mandrel initially from the starting point “2”. And the other sheets are wrapped about the mandrel in the same way. It can be seen that for the overlapping place of the front end and the rear end of each sheet is dispersed, the section made according to this method would have a uniform wall thickness.

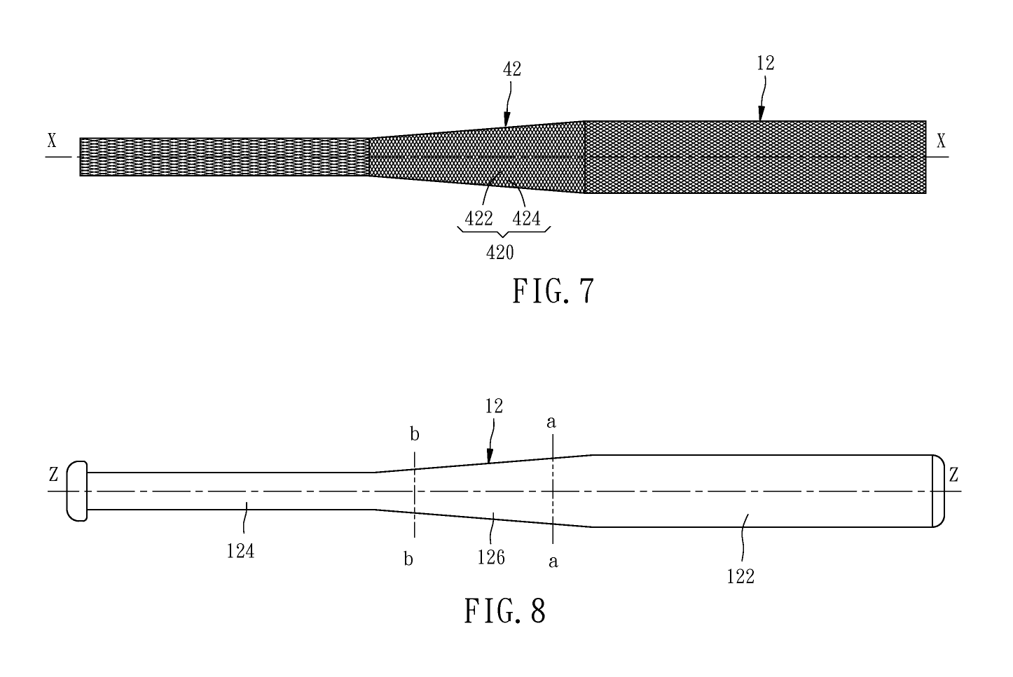

Referring further to FIG. 7, In another aspect of the method according to the present invention, the coupling area of the first connecting portion 226 and the second connecting portion 326 can be encased by a reinforced tubular member 42 made of a carbon fiber-reinforced epoxy sheet 420 with a set of left-extended fibers 422 and a set of right-extended fibers 424. The set of left-extended fibers 422 extend at +60 degrees relative to the longitudinal axis X-X′ of the bat body 12. The set of right-extended fibers 424 extend at −60 degrees relative to the longitudinal axis X-X′ of the bat body 12.

Referring lastly to FIGS. 8 to 11, a bat body 12′ is a third preferred embodiment according to the present invention. The bat body 12′ extends along a longitudinal axis Z-Z′ and has a front section 122′, a rear section 124′ and a middle section 126′ located therebetween, which are separated by dotted lines a-a′ and b-b′ as shown in FIG. 8.

The front section 122′ includes a front tubular member 50 made of a carbon fiber-reinforced epoxy sheet 52. The sheet 52 has a first set of left-extended fibers 522 and a first set of right-extended fibers 524. The first set of left-extended fibers 522 extends at +30 degrees (the plus first angle) relative to the longitudinal axis Z-Z′ of the bat body 12′. The first set of right-extended fibers 524 extends at −30 degrees (the minus first angle)relative to the longitudinal axis Z-Z′ of the bat body 12′. The sheet 52 further has a first saw-toothed connecting portion 526 disposed on one end thereof.

The rear section 124′ includes a rear tubular member 60 made of a glass fiber-reinforced epoxy sheet 62. The sheet 62 has a second set of left-extended fibers 622 and a second set of right extended fibers 624. The second set of left extended fibers 622 extends at +10 degrees (the plus second angle) relative to the longitudinal axis Z-Z′ of the bat body 12′. The second set of right-extended fibers 624 extends at −10 degrees (the minus second angle) relative to the longitudinal axis Z-Z′ of the bat body 12′. The sheet 62 further has a second connecting portion 626 disposed on one end thereof. In this embodiment, the second connecting portion 626 is sliced into a plurality of strips.

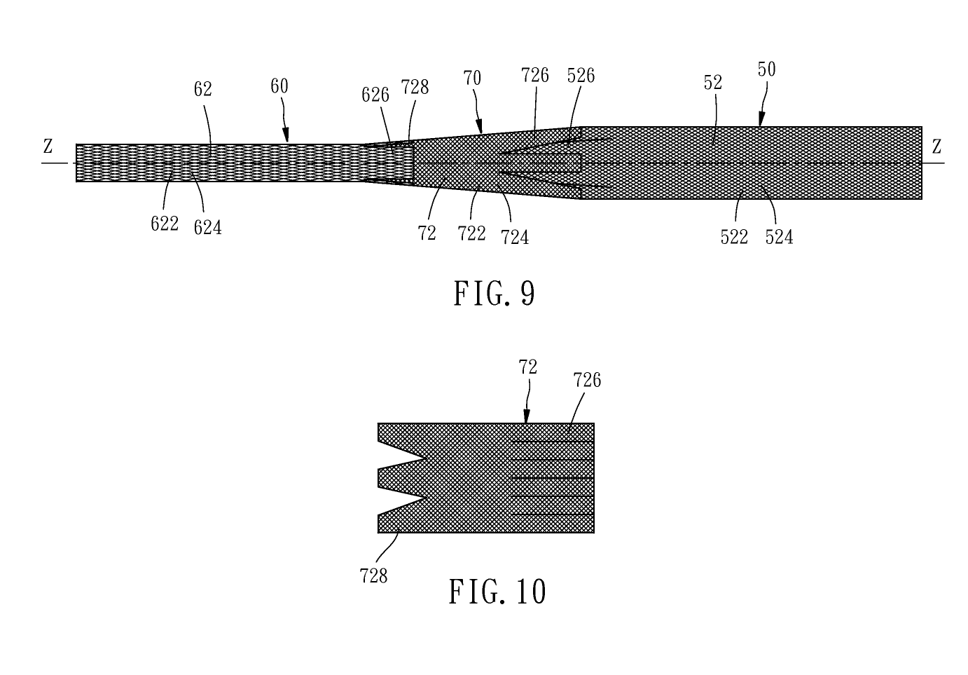

The middle section 126′ includes a middle tubular member 70 made of a third carbon fiber-reinforced epoxy sheet 72. The sheet 72 has a third set of left-extended fibers 722 and a third set of right-extended fibers 724. The third set of left-extended fibers 722 extends at +45 degrees (the plus third angle) relative to the longitudinal axis Z-Z′ of the bat body 12′. The third set of right-extended fibers 724 extends at −45 degrees (the minus third angle) relative to the longitudinal axis Z-Z′ of the bat body 12′. The sheet 72 further has a third connecting portion 726 disposed on one end thereof and a fourth connecting portion 728 disposed on the other end thereof. In this embodiment, the third connecting portion 726 is sliced into a plurality of strips and the fourth connecting portion 728 is saw-toothed, as shown in FIG. 10. In combination, the third connecting portion 726 and the first connecting portion 526 are linked up overlappingly and the fourth connecting portion 728 and the second connecting portion 626 are linked up overlappingly, as shown in FIG. 9.

In this embodiment, for having the middle tubular member 70 and the degrees of the third angle being greater than that of the first angle, the bat body 12′ can have a more flexible hitting area and a pivot area that can bear more twisting force than any other bat body.

The method for producing the bat body 12′ comprises the steps of:

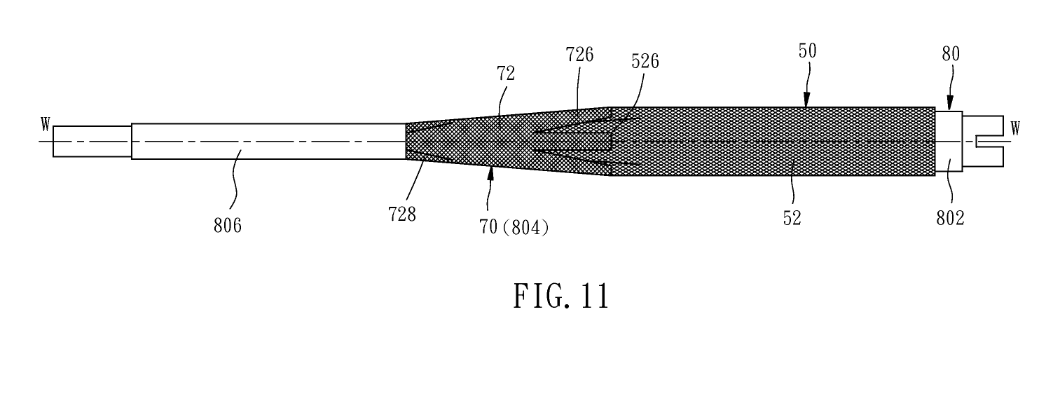

preparing a mandrel 80 with an air bladder and extending along a longitudinal axis W-W′, as shown in FIG. 11;

preparing a first carbon fiber-reinforced epoxy sheet 52 with a first saw-toothed connecting portion 526;

wrapping the sheet 52 about a first portion 802 of the mandrel 80 to form the front tubular member 50;

preparing a third carbon fiber-reinforced epoxy sheet 72 with a third connecting portion 726 disposed on one end thereof and a fourth connecting portion 728 disposed on the other end thereof, the third connecting portion 726 being sliced into a plurality of strips and the fourth connecting portion 728 being saw-toothed, as shown in FIG. 10;

wrapping the sheet 72 about a second portion 804 of the mandrel 80 in such a way that the third connecting portion 726 linked up overlappingly with the first saw-toothed connecting portion 526 of the first carbon fiber-reinforced epoxy sheet 52 to form the middle tubular member 70 coupled with the front tubular member 50;

preparing a glass fiber-reinforced epoxy sheet 62 with a second connecting portion 626 being sliced into a plurality of strips;

wrapping the sheet 62 about a third portion 806 of the mandrel 80 in such a way that the second connecting portion 626 is linked up overlappingly with the fourth saw-toothed connecting portion 728 of the third carbon fiber-reinforced epoxy sheet 72 to form the rear tubular member 60 coupled with the middle tubular member 70;

placing the tubular members 50, 60 and 70 into a mold; and

compacting the tubular members 50, 60 and 70 with 12 KG/CM2 by the air bladder and simultaneously heat curing them at 140° C.˜150° C. in a period of time to form the bat body 12′.

In an alternative preferred embodiment, for the middle section 126′ is a tapered region between the front section 122′ and the rear region 124′, the third carbon fiber-reinforced epoxy sheet 72 is divided into a plurality of pieces so that it can be easily wrapped about the mandrel 80 to form the middle tubular member 70. For example, we can divide the sheet 72 into three pieces, and then wrap each piece about the mandrel 80 along the longitudinal axis W-W′ thereof to form the middle tubular member 70.

While the preferred embodiments of the invention have been illustrated and described, it will be appreciated that various changes can be made therein without departing from the spirit and scope of the invention.

What is claimed is:

1. A bat body extending along a longitudinal axis and comprising:
a front section and a rear section coupled with said front section;
said front section including at least a first tubular member;
said rear section including at least a second tubular member;
said first tubular member comprising a first fiber-reinforced resin sheet having a first set of left-extended fibers and a first set of right-extended fibers, said first set of left-extended fibers extending at a plus first angle relative to the longitudinal axis of said bat body, said first set of right-extended fibers extending at a minus first angle relative to the longitudinal axis of said bat body, and said first fiber-reinforced resin material sheet having a first connecting portion disposed on one end thereof;
said second tubular member comprising a second fiber-reinforced resin sheet having a second set of left-extended fibers and a second set of right-extended fibers, said second set of left-extended fibers extending at a plus second angle relative to the longitudinal axis of said bat body, said second set of right-extended fibers extending at a minus second angle relative to the longitudinal axis of said bat body, and said second fiber-reinforced resin sheet having a second connecting portion disposed on one end thereof; and
said first connecting portion of said first fiber reinforced resin sheet and said second connecting portion of said second fiber reinforced resin sheet being linked up in an un-overlapping or overlapping way.

2. The bat body of claim 1, wherein the degrees of said first angle are different from that of said second angle.

3. The bat body of claim 1, wherein the fiber or resin of said first fiber-reinforced resin sheet is different from that of said second fiber-reinforced resin sheet.

4. The bat body of claim 1, wherein the number of said first tubular members of said front section is different from the number of said second tubular members of said rear section.

5. The bat body of claim 4, wherein the number of said first tubular members of said front section is different from that of said second tubular members of said rear section.

6. The bat body of claim 1, wherein one of said fiber-reinforced resin sheets comprises a plurality of pieces.

7. The bat body of claim 1, wherein said first connecting portion of said first fiber-reinforced resin sheet is saw-toothed.

8. The bat body of claim 1, wherein said second connecting portion of said second fiber-reinforced resin sheet is sliced into a plurality of strips.

9. The bat body of claim 1, further comprising a middle section located between said front and rear section, said middle section including at least a third tubular member; said third tubular member comprising a third fiber-reinforced resin sheet having a third set of left-extended fibers and a third set of right-extended fibers, said third set of left-extended fibers extending at a plus third angle relative to the longitudinal axis of said bat body, said third set of right-extended fibers extending at a minus third angle relative to the longitudinal axis of said bat body, said third fiber-reinforced resin sheet having a third connecting portion disposed on one end thereof and a fourth connecting portion disposed on the other end thereof; said third connecting portion of said third fiber reinforced resin sheet and said first connecting portion of said first fiber reinforced resin sheet being linked up in an un-overlapping or overlapping way, and said fourth connecting portion of said third fiber reinforced resin sheet and said second connecting portion of said second fiber-reinforced resin sheet being linked up in an un-overlapping or overlapping way.

10. The bat body of claim 1, wherein the degrees of said first angle are 30 and the degrees of said second angle are 10.

11. The bat body of claim 9, wherein the degrees of said third angle are greater than or equal to that of said second angle.

12. The bat body of claim 11, wherein the degrees of said first angle are 30, the degrees of said second angle are 10, and the degrees of said third are 45.

13. A method of producing the bat body of claim 1, the method comprising:
preparing a mandrel with an air bladder and a longitudinal axis; preparing a first fiber-reinforced resin material sheet having a first set of left-extended fibers and a first set of right-extended fibers, said first set of left-extended fibers extending at a plus first angle relative to the longitudinal axis of said mandrel, said first set of right-extended fibers extending at a minus first angle relative to the longitudinal axis of said mandrel;
disposing a first connecting portion on one end of said first fiber-reinforced resin material sheet;
wrapping said first fiber-reinforced resin material sheet about a first part of said mandrel to form a first tubular member;
preparing a second fiber-reinforced resin sheet having a second set of left-extended fibers and a second set of right-extended fibers, said second set of left-extended fibers extending at a plus second angle relative to the longitudinal axis of said mandrel, said second set of right-extended fibers extending at a minus second angle relative to the longitudinal axis of said mandrel;
disposing a second connecting portion on one end of said second fiber-reinforced resin material sheet;
wrapping said second fiber-reinforced resin sheet about a second part of said mandrel in such a way that said second connecting portion of said second fiber reinforced resin sheet is linked up un-overlappingly or overlappingly with said first connecting portion of said first fiber-reinforced resin sheet to form a second tubular member coupled with said first tubular member;
placing said first and second tubular members into a mold; and
compacting and simultaneously heat curing said first and second tubular members in a period of time for hardening said first and second tubular members to form said bat body.

14. The method of claim 13, wherein the number of said first tubular members of said front section is different from that of said second tubular members of said rear section.

15. The method of claim 14, wherein the starting point of each of fiber-reinforced resin sheets to wrap about said mandrel is different.

16. The method of claim 13, further comprising the steps of:
preparing a third fiber-reinforced resin material sheet having a third set of left-extended fibers and a third set of right-extended fibers, said third set of left-extended fibers extending at a plus third angle relative to the longitudinal axis of said mandrel, said third set of right-extended fibers extending at a minus third angle relative to the longitudinal axis of said mandrel;
disposing a third connecting portion on one end of said third fiber-reinforced resin material sheet and a fourth connecting portion on the other end of said third fiber-reinforced resin material sheet;
wrapping said third fiber-reinforced resin sheet about a third part of said mandrel in such a way that said third connecting portion of said third fiber reinforced resin sheet is linked up un-overlappingly or overlappingly with said first connecting portion of said first fiber-reinforced resin sheet and said fourth connecting portion of said third fiber reinforced resin sheet is linked up un-overlappingly or overlappingly with said second connecting portion of said second fiber-reinforced resin sheet to form a third tubular member respectively coupled with said first and second tubular members.

17. The method of claim 16, wherein the degrees of said first angle are 30, the degrees of said second angle are 10, and the degrees of said third are 45.

18. The method of claim 16, wherein said third fiber reinforced resin sheet is divided into a plurality of pieces to be easily wrapped about said third part of said mandrel.
